(19) United States
(12) Patent Application Publication
(10) Pub. No.: US 2008/0086436 A1
(43) Pub. Date: Apr. 10, 2008

(54) KNOWLEDGE PATTERN SEARCH FROM NETWORKED AGENTS

(75) Inventors: YING ZHAO, Cupertino, CA (US); Charles Chuxin Zhou, Cupertino, CA (US)

Correspondence Address: QUANTUM INTELLIGENCE, INC.;DR. CHARLES C. ZHOU, 3375 SCOTT BLVD., SUITE 100, SANTA CLARA, CA, 95054-3111, US

(73) Assignees: Dr. Ying Zhao, Cupertino, CA (US); QUANTUM INTELLIGENCE, INC., SANTA CLARA, CA (US)

(21) Appl. No.: 11/875,754

(22) Filed: Oct. 19, 2007

Related U.S. Application Data
(60) Provisional application No. 60/962,954, filed on Aug. 1, 2007.

(51) Int. Cl. G06F 15/18

(52) U.S. Cl. 706/12

(57) ABSTRACT

A method searches for new, unique and interesting information using knowledge patterns discovered through data mining and text mining, machine learning (including supervised or unsupervised) and pattern recognition methods. The method is implemented as a computer program acting as an agent installed in a computer node or multiple nodes in a networked environment. The system is useful for improving search experience and used in knowledge discovery applications when new, unique and interesting information is critical. The system is also useful for introducing new concepts and products for business applications.

### FIELD OF THE INVENTION

The present invention relates to a system, method, computer program product which discovers and searches for new, unique and interesting information using knowledge patterns discovered through data mining and text mining, machine learning (supervised, unsupervised) and pattern recognition methods. The knowledge patterns are then incorporated into a search application that helps businesses, organizations and individuals search and discover new information.

### BACKGROUND OF THE INVENTION

Firstly, the present art is related to advanced search engine for information search and retrieval. One of major drawbacks of the current search engines is that they typically sort documents based on the popularity of documents among all the linked documents. Since a popular information is not usually new or unique, therefore it may not be useful for many applications where one wants to look for new, unique and interesting information that may be not popular or known by many people. The kind of information may provide predictions for early warnings, anomalies and valuable business opportunities.

The current relevance ranking is based on the assumption of linked documents or databases, not semantics, therefore, it may not be applied to the search needs where links of documents are not available, for example, documents within extended enterprises which are often not cross-linked like in the world wide web.

Semantic machine understanding, extracting meaning, discovering events, relationships, trends can be very challenging tasks and currently can only be done in small scales, rarely used in large-scale search applications. There are a number of extant tools for data and text mining in the advanced search engines such as keyword analysis and tagging technology. Many of the current search engines employ advanced search assistant and language tools. For example, as you type, these tools offer suggestions of keywords. However, these products cannot suggest new concepts drastically different but semantically related or have predictive capabilities to a search word.

Better tools are needed to fully leverage knowledge patterns discovered in the data to achieve large-scale semantic search, for example, to find new, unique and interesting information with respect to a search context.

Secondly, there is increasing need to share mining results and search indexes across multiple organizations and extended enterprises that require analysis of open-source (uncertain, conflicting, partial, non-official) data. Teams will consist of culturally diverse partners with rapidly changing team members and various organizational structures. The information, including structured data from databases and unstructured data such as text, is enormous and often naturally distributed among millions of computers around the world. It is difficult to move such huge amount data into a centralized location, for example, like the way a current web crawler goes out to collect all the web pages to a central location, is very expensive. Therefore, the current search engine business is very expensive because it has to copy and store all the data locally before it can index them. In order to respond to this challenge, more powerful information analysis tools are needed that can quickly extract meaning and intent from where the data is originally gathered. The mining results or indexes are then to be accessed across the network without leaving the local computers.

Thirdly, shared indexes might be across multiple organizations and cultures, the index and mining engine has to be language/culture-independent which means it can not use any linguistic based approaches. Indexes and information mining results have to be represented in a language/culture free format. Statistical methods are widely researched and used to improve information indexing, search/retrieval, and text categorization. However, many are difficult to scale-up.

Lastly, semantic understanding and semantic search on open-source and uncertain data, it is hard to assume any meaning can be static and in a centralized location, therefore, the infrastructure has to be peer-based. It is increasingly interesting both militarily and commercially to apply peer-to-peer (P2P) technologies to store, locate and understand information, where agent-like applications are distributed among a grid of computers. Each agent is considered itself as a peer or node among a network of similar applications. The infrastructure is “fault-tolerate”, “distributed”, and “self-scalable”. With all the great advantages of a P2P concept, however, the current P2P lacks the technology to learn the experience or meaning from historical data and real-time human interactions. Also a peer is often overwhelmed by a number of peers in the network that needs to go through. P2P networks are also associated with so-called “grid computing”, where a personal computer joins a network of similar computers to perform a complex computation. However, because of lacking incentives for personal computers to join the network, it is a difficult to share the resource.

### SUMMARY OF THE INVENTION

Our invention scores a piece of information based on its association to knowledge patterns that are discovered from the historical data. Knowledge patterns are the summarized characteristics and grouped semantic meanings in the data. Our invention scores a piece of information based on their newness, interestingness and uniqueness with respect to a search context, outputs correlated concepts or keywords with respect to a search context, making it possible to infer, predict and project future actions based on early indications and warnings. In our invention, multiple nodes across a network install exactly same computer programs, which act as agents to gather, index and mine structured and unstructured data locally where an agent is installed. The agents are then linked together to form a distributed search network. Each agent owns its own data model, mining and index results locally. As a whole, the networked agents, their data models and their search indexes can be accessed from anywhere in the network. Each agent is customized to the mining, learning and discovering of knowledge patterns according to the agent's individual and local data. This allows data providers to maintain their own data in their own environment, but still share and use the information across a collaborative network.

### BRIEF DESCRIPTION OF THE DRAWINGS

FIG. 1: A single agent process in a knowledge gathering network.

FIG. 2: The data gathering process using a defined schema.

FIG. 3: Import engine with adapters for diversified data sources to a XML warehouse.

FIG. 4: Transformation engine transforms data in a XML warehouse.

FIG. 5: Knowledge pattern discovery process.

FIG. 6: Apply knowledge patterns for detection, monitoring and prediction.

FIG. 7: Components in A Knowledge Visualizer.

FIG. 8: Link to other agents to form a search network.

FIG. 9: A collaborative search returns search results from a search network.

FIG. 10: Interactions and relations between parts.

FIG. 11: Components and their interactions in a Knowledge Gathering Network.

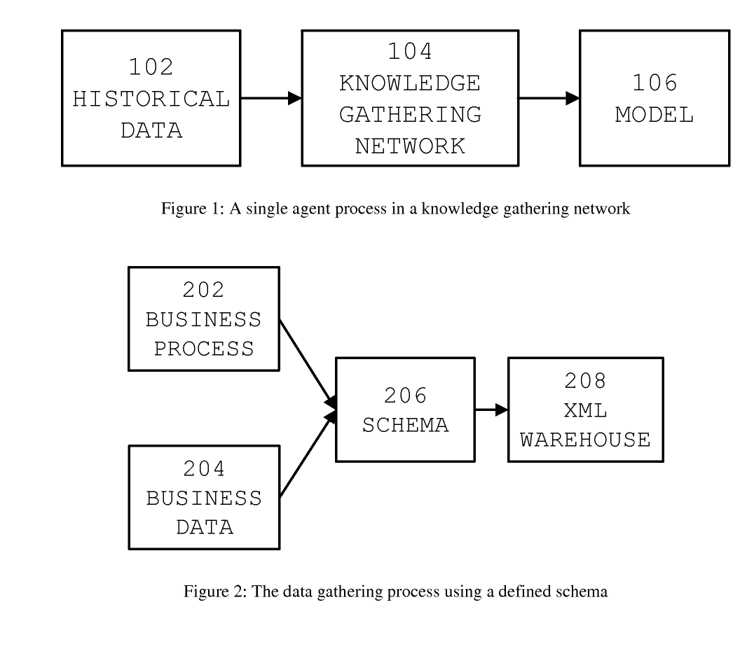

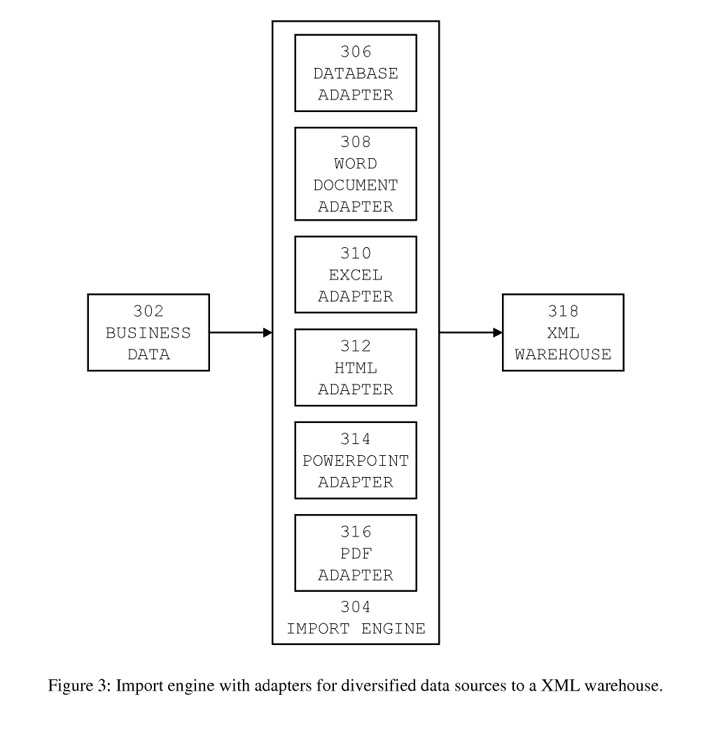

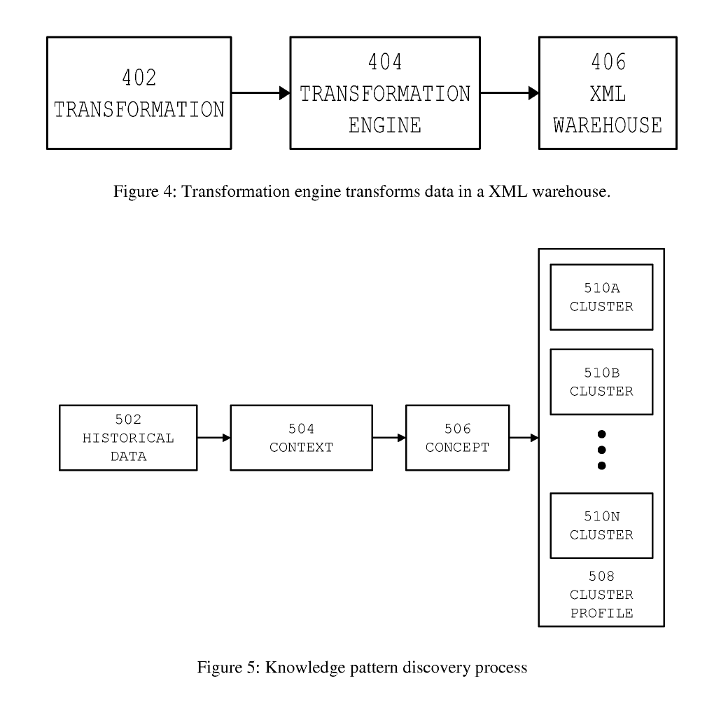

### DETAIL DESCRIPTION OF THE INVENTION

The invention include five parts

Part 1: Knowledge Gathering Network

In this part, a knowledge gathering network is a total view of information, knowledge and objects that are engaged in a business or knowledge management process (202). Knowledge Gathering Network (KGN) is a XML based knowledge gathering, creation and dissemination system (104, 1002) that mines, learns and discovers knowledge patterns from historical data (102). The knowledge patterns are stored as a model (106) locally in the agent. It contains the following components:

Component 1—Gather Data (1102): defines at a high-level how business data (204, 302, 602) is organized and flows into a business or knowledge management process (202). A XML data schema or ontology (206) describes how concepts are hierarchically organized in the process to store them into an XML Warehouse (208).

Component 2—Import into XML Warehouse (1104): ETL tools in the import engine (304) include adapters for extracting data from a database (306), word document (308), Excel (310), HTML (312), PDF (314) or PPT (316) source. Transformation tools (402) in the transformation engine (404) built from XSLT are used for loading data into a XML warehouse (208, 318, 406) according to the schema (206).

Component 3—Discover Knowledge Patterns (1106): Discover correlations and patterns in the XML Warehouse using the context, concept and cluster algorithm. The warehouse contains raw observations or inputs for a collection of hierarchical objects as for mining. Mining can be applied to the objects at any level of the hierarchy. Their input observations can be text, numeric data or any form of symbolic languages used to describe the characteristic of an object. For numeric data, transformations (402) are used to change the numeric data into symbols.

The context, concept and cluster algorithm is used for information mining. A context (504) is a symbol which occurs frequently in a symbolic system. A concept (506) is a group of symbols that either appear frequently together or appear frequently together with a same context; therefore, they are connected by meaning. An object cluster (510) is a characteristic group of objects grouped according to the concepts. The contexts and concepts are discovered automatically. The object cluster profile (508) is the foundation of knowledge patterns (604). These knowledge patterns include, for example, similarity pattern, correlation pattern, prediction pattern, recommendation pattern, and trend pattern. A similarity pattern (606) refers to a group of concepts that are used to describe how objects are similar to each other. A correlation pattern (608) can be either a group of concepts that are associated with each other because they are used to describe similar objects or a group of concepts showing predictive power and acting as earlier indications of another group of concepts. A prediction pattern (610) establishes a predictive relationship between an earlier observed concept and a later observed concept through supervised learning of historical data, therefore a later observed concept can be predicted from the earlier one. A recommendation pattern (612) is a prediction pattern that is derived without or with little historical data. A trend pattern (614) is a prediction pattern with multiple future predictions.

Component 4—Apply Knowledge Patterns (1108): Knowledge patterns can be viewed as normal behaviors of the participants in a business or knowledge management process. They are used to contrast, detect and predict abnormal behaviors, anomalies or new opportunities that might come to the network in a dynamic, real-time fashion. Knowledge patterns are used to monitor and understand real-time new data feed. They can also be used to regulate a business process.

Part 2: Knowledge Pattern Visualization

A single model (702) from a single agent can be viewed using the Visualizer (704). Patterns are displayed in clusters and concepts sorted according to a chosen metric in the Profiler Analysis (706). Similarity patterns, correlation patterns and recommendation patterns are viewed in the Profiler Analysis (706) and the Association Analysis (708). The prediction patterns are viewed in the Gains Analysis (710) view.

Part 3: Knowledge Pattern Link

Each agent (802A, 802B, 802C, . . . , 802N) mines, learns and discovers its own knowledge patterns using its own domain specific data sets, then it links to the other agents to form a search network. This is done by listing other agents in its peer list.

Part 4: Collaborative Knowledge Pattern Search

A web client (902) can search and find information from a search network (906) formed by the search agents (904A, 904B . . . 904N) in the network. The ranking of the result is decided on a measure of how it is uniquely linked to a search context.

How do these Components or Steps Work Together, and how is the Invention Used?

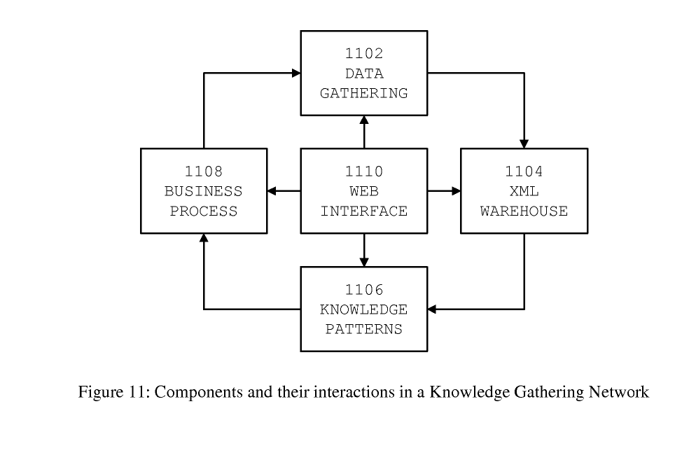

Components work together as an integrated system including building models illustrated in FIG. 10 and in FIG. 11, with the Knowledge Gathering Network (1002), exploring models through the Visualizer (1004), linking to other agents (1006), and searching and discovering through the Knowledge Pattern Search (1008). Discovery applications may include anomaly detection.

The drawing in FIG. 11 shows the components in Part 1: Knowledge Gathering Network working together. A web interface (1110) is used in connecting all the components.

The present method to search and identify knowledge patterns can be very useful to learning from business data mixed with data and text, for example, how to identify something out of ordinary? How to identify severe problems earlier? Who are my customers? Who are the most profitable customers? Where are my new business opportunities? The present method can be also applied to select a set of information for business opportunities. For example, select a set of companies for investing by applying correlation and prediction patterns between a desired business impact (e.g. stock price) and description of business activities (e.g. business news). The method is used to help a user capture a small window of opportunity during the information dissemination process using a predictive pattern. The present method can be very useful to perform a method to discover the associations among a list of items, e.g. a list of words describing a specific domain, a list of products for a business, or a list of genes and biological pathways for a population of organisms. The associations among words show their connected meaning. The associations among products provide cross-sell opportunities. The associations among genes and biological pathways provide further understanding of biological mechanisms. The present method can be used to introduce a new concept or a new product where a current search engine of popularity-based ranking is not able to achieve. The relevance of new concept or product is computed based on its uniqueness and interestingness with respect to a search context which is known to substantial amount of people. Since a search keyword usually represents a search user's area of interest, the new concepts or new products can be discovered that matches a search user's area of interest, this not only provides new information and opportunities for the search user, but also provide the unique marketing opportunities for the new product or concept owners. This provides an opportunity to award new and innovative ideas that associate with established and known contexts. Also using the present method, businesses and organizations can also deploy multiple agents where each one is only responsible for, indexes and learns patterns from a small portion of the whole information. Then all the indexes are shared across the entire business chain, which may include suppliers, customers and partners. This way, the whole information is shared across the stakeholders without the need to move the data to a centralized location.

The implementation of the present method as a computer agent installed in a distributed network creates business opportunities for each agent being rewarded by linking and discovering new information sources. The invention can be applied to sense making applications in a collaborative team problem solving environment. The meaning, defined as a set of cognitive states here, is interpreted from team communication inputs. For example, when a team member shows body language (written as “pointing to the map” in the transcript) as raw input, it may mean a cognitive state of “individual visualization and representation of meaning”. Another example would be if a team member said “um hum”, it may map to the cognitive state of “convergence of individual mental models to team mental model”. The invention is able to predict such psychological meaning by applying correlation patterns from team communication inputs. This can be used for multi-national, multi-cultural and coalition decision-making applications. Each nation, culture or coalition partner can have its own set of agents trained using their nation- and culture-specific data. A recommendation process can be optimized for decision making, guided by knowledge patterns discovered from multiple agents. While a search context might represents a potential course of action, a search result, which also returns positive or negative sentiment, can help decide which course of action to take.

What is claimed is:

1. A method of searching and ranking a piece of information according to a score of newness, interestingness and uniqueness calculation for a given piece of information, which is composed of using a set of symbols or vocabularies as keywords into a logic or semantic sequence for a specific domain, comprising
Calculating the newness, interestingness and uniqueness of a piece of information based on the keyword associations with respect to a search context

2. The method of claim 1, wherein calculating the newness, interestingness and uniqueness of a piece of information includes
Deciding a set of associated keywords for each search context. The decision is dependent on how likely or probability of a keyword that occurs together with a search context

3. The method of claim 1, wherein calculating the newness, interestingness and uniqueness of a piece of information includes
Deciding a set of associated keywords for each search context. The decision is dependent on the correlations of a search keyword with respect to other keywords within a context, where a context is defined as keywords within some proximity to a search keyword.

4. The method of claim 1, wherein calculating the newness, interestingness and uniqueness of a piece of information includes
Deciding a set of associated keywords for each search context. The decision is dependent on categorizing the meaning of a large collection of information into characteristic groups and then associating keywords into the meaning groups.

5. The method of claim 1, wherein calculating the newness, interestingness and uniqueness of a piece of information includes
Calculating the distribution of a search result, which is a set of information matching the search keyword, among meaning groups.

6. The method of claim 1, wherein calculating the newness, interestingness and uniqueness of a piece of information includes
Generating correlated concepts with respect to a search context, and use them to infer, predict and project future outcomes based on early indications and warnings that are described by the correlated concepts.

7. The method of claim 1, wherein calculating the newness, interestingness and uniqueness of a piece of information includes
Distributing and customizing indexes embed in agents to the learning and knowledge patterns of its own environment and culture. Maintaining all data/indexes locally in a distributed environment.

8. The method of claim 1, wherein calculating the newness, interestingness and uniqueness of a piece of information includes
Using semantical machine understanding, data and text mining, supervised or unsupervised machine learning, pattern recognition methods to compute the relevance in favor of new, unique and interesting information rather than popular information.

9. A method of associating and correlating the keywords with a large set of meaning groups, each meaning group being characterized using keywords learning from local data stores, comprising:
Leaning the meaning groups or clusters and extracting the keywords that characterize them from a large collection of information automatically, The meaning groups are dependent on strength of the contained keywords or concepts associated with automatically selected contexts.

10. The system of claim 9, wherein grouping the meaning of information includes
Automatically selecting contexts for other keywords to be associated with.

11. The system of claim 9, wherein grouping the meaning of information includes Automatically forming concepts which are groups of keywords.

12. The method of claim 9, wherein grouping the meaning of information includes Automatically grouping information into characteristic groups or clusters based on their projections to the concepts.

13. The method of claim 9, wherein grouping the meaning of information includes
Automatically characterizing a meaning using concepts

14. A method of searching and finding new and interesting information from a distributed network, comprising
Generating a computer program acting as an agent, who is a member or participant of a knowledge gathering network, can learn, search and find new, unique and interesting information from its local data stores and also goes to its peer list to look for better matches. Each member in a knowledge gathering network is coded exactly the same. The only difference for the agents are their local data stores and their peer lists.

15. The method of claim 14, wherein the computer implemented method to act as an agent, comprising
Forming a multi-agent network. Each agent is the same as others except for the data it tries to manage locally. The agents are then linked together to form a distributed search network. Each agent owns its own data model, mining and index results. As a whole, the networked agents, their data models and their search indexes can be shared and accessed from anywhere in the network. Each agent is customized to the mining, learning and discovery of knowledge patterns according to the agent's individual and local data.

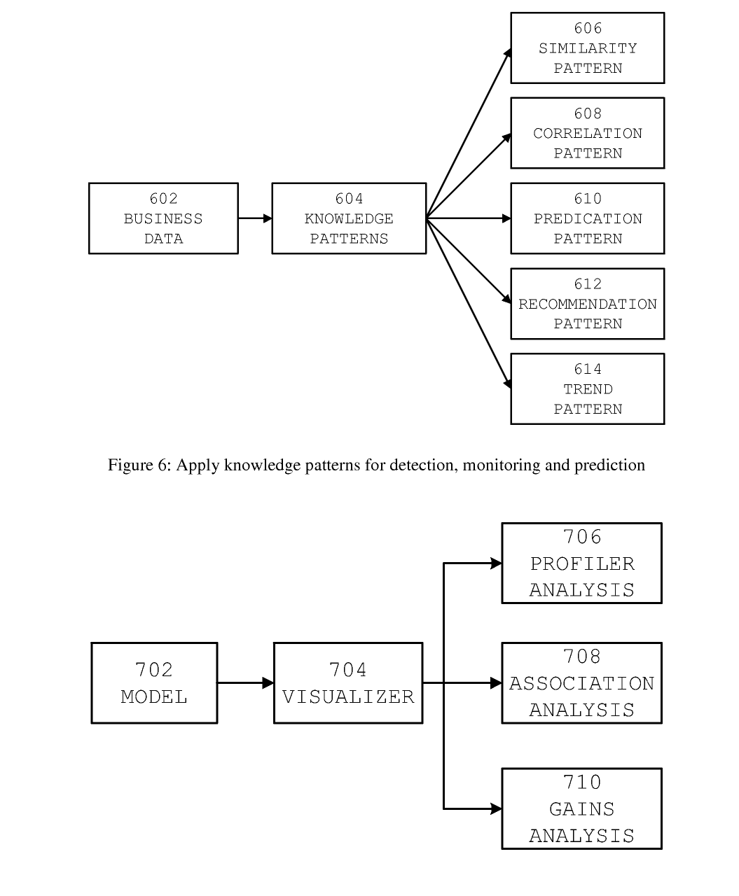

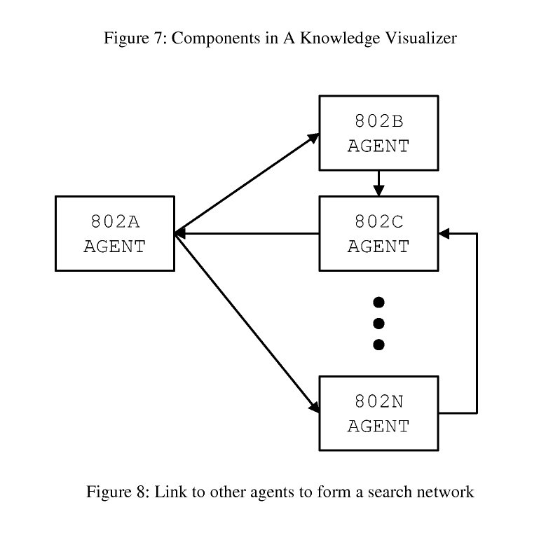

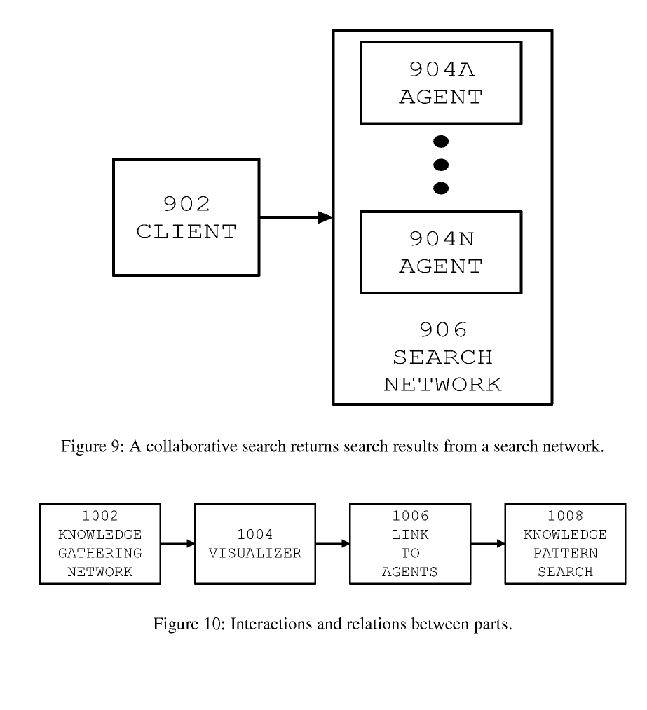

16. The method of claim 14, wherein the computer program to act as an agent, comprising
Learning knowledge patterns from its local information stores, this being done using a 1-click mining process. The 1-click mining process includes automatically learning and discovering contexts, concepts and clusters (FIG. 5) and discovering the knowledge patterns includes similarity pattern, correlation pattern, predictive pattern, recommendation patterns and trend pattern (FIG. 6) in a single step in the computer program acting as an agent.

17. The method of claim 14, wherein the computer implemented method acting to act as an agent can also reference other agents by putting the other agents into its peer list, comprising
Listing other agents as peers so they can be referenced. Displaying referrers in the ranked search results where referrers of highly ranked new, unique and interesting information are reported.

18. A computer program that stores instructions executable by one or more processors to perform a method of searching and finding new, unique and interesting information, comprising
Instructions of using data mining, text mining, machine learning (supervised, unsupervised) and pattern recognition methods to profile, group and cluster objects and then applying the knowledge patterns to a search application to find new, unique and interesting information.
Instructions for scoring newness, interestingness and uniqueness of a piece of information, sorting information based the scores and displaying and annotating the newness, interestingness and uniqueness measures and referrers in a search result. Such measure is a prediction of a search result's impact in real life with respect to a search context, for example, could be predictive patterns of early warnings, anomalies and business opportunities.

19. A computer program that stores instructions executable by one or more processors to perform a method of maintaining their own data in their own environment, however, shared and used the information across a collaborative network, including
Instructions for indexing, mining and indexing the local data and collaborating with a network of peers.

20. A computer program that stores instructions executable by one or more processors to perform a method of sense making in a collaborative team problem solving environment. The meaning, may be defined as a set of cognitive states here, is interpreted from team communication inputs, comprising
Instructions for predicting psychological states from team communication inputs.

21. A computer program that stores instructions executable by one or more processors to perform a method of multi-national, multi-cultural and coalition decision-making, comprising
Instructions for recommending actions for decision making. While a search context might represents a potential course of action, a search result, which also returns positive or negative sentiment, can help decide which course of action to take.
